(19) United States
(12) Patent Application Publication
(10) Pub. No.: US 2024/0208556 A1
(43) Pub. Date: Jun. 27, 2024

(54) CART WITH A MAIN BODY AND REMOVABLE WHEELED BODY

(71) Applicant: VELTEK ASSOCIATES, INC., MALVERN, PA (US)

(72) Inventor: Kenneth Shawn CHRISTIANSON, Clayton, DE (US)

(21) Appl. No.: 18/390,729

(22) Filed: Dec. 20, 2023

Related U.S. Application Data
(60) Provisional application No. 63/434,314, filed on Dec. 21, 2022.

(51) Int. Cl. B62B 3/02; B62B 3/00; B62B 3/04

(52) U.S. Cl. CPC B62B 3/02; B62B 3/005; B62B 3/04

(57) ABSTRACT

A main body and a wheeled body. The main body includes shelves, support posts that support the shelves, and guide wheels mounted to a first shelf of the shelves. The wheeled body include a platform for slidingly receiving the guide wheels of the main body. The wheeled body can also include wheels mounted to a bottom of the platform and a lock. The lock can include a notch having dimensions that are complementary to dimensions of each of the transverse side frames. The lock can releasably lock to one of the transverse side frames to restrict longitudinal movement of the main body relative to the wheeled body. The lock is wholly incorporated onto the wheeled body.

### RELATED APPLICATIONS

This application claims the benefit of priority of U.S. Provisional Application No. 63/434,314, filed on Dec. 21, 2022, the entire content of which is relied upon and incorporated herein by reference in its entirety.

### TECHNICAL FIELD

The present disclosure relates to the field of clean room equipment. More particularly, the present disclosure is directed to equipment for the transport of items from a non-sterile environment to a sterile environment and vice versa.

### BACKGROUND

A controlled environment (such as a clean room) can be an area or environment in which the level of contaminants or particles is controlled, such as by filtering particulate matter from air that enters the room. Controlled environments can have low levels of contaminants or particles, and can be used to manufacture certain products and conduct research. Controlled environments can be used to ensure that organic and inorganic contaminants from the outside environments do not compromise certain goods or equipment. However, it can be difficult to transport various items (such as supplies, raw materials, etc.) into the controlled environment without contaminating the controlled environment or otherwise introducing particles into the controlled environment.

Clean rooms can also use such features as positive pressure and humidity controls to optimize the environment for the task for which they have been designed. Clean rooms can have a variety of sizes, and can also have an airlock or staging area formed outside of the entry point. The airlock or staging area can sequester the air inside the clean room from the outside environment. Clean rooms can be classified using filtration criteria that examines the number and size of particles admitted in a given air volume. Clean room standards can include US FED 209E classes, ISO 14644-1 classes, and ISO 14644-2 classes.

Autoclaving is one technique for cleaning the items and equipment to be transported into the controlled environment. An autoclave is a device that is used to sterilize goods and equipment through the use of pressure and/or heat in the form of steam or superheated water. Autoclaving can also be carried out in a vacuum. Autoclaves can have a variety of sizes, depending on the media to be sterilized. Because the goods and equipment in the autoclave are subjected to high levels of heat, pressure, and moisture, any media subjected to such treatment should be able withstand high levels of heat, pressure, and moisture.

Clean room personnel can use supply transport devices, such as carts, to transport items to/from a clean room. However, carts from uncontrolled environments should not enter the clean room because the wheels can attract dirt that would introduce undesirable particles into the clean room. Consequently, personnel often stop the cart outside the clean room entry point (or inside the staging area), then manually transfer trays and/or goods from the cart to inside the sterile environment.

A second cart can sometimes be provided inside the clean room, and the goods can be transferred to/from the cart located inside the clean room to/from the cart located outside the clean room, as shown in U.S. Pat. Nos. 10,518,793, 9,994,244, and 11,555,576. This transfer can ensure that the cart situated outside the clean environment does not enter and contaminate the sterile clean room. But, there is a need to improve the manufacturability and reduce costs associated with existing transfer devices and to improve usability of the devices.

### SUMMARY

These needs are met, to a great extent, by a device that includes a main body and a wheeled body. The main body may include shelves, which may include a first shelf. The first shelf may include transverse side frames. The main body may include support posts that support the shelves and guide wheels mounted to the first shelf. The wheeled body may include a platform that can slidingly receive guide wheels of the main body; wheels mounted to a bottom of the platform; and a lock. The lock may include a notch having dimensions that are complementary to dimensions of each of the transverse side frames. The lock can releasably lock to one of the transverse side frames to restrict longitudinal movement of the main body relative to the wheeled body. The lock is wholly incorporated onto the wheeled body.

Implementations may include one or more of the following features. The device where the lock may include a base that is fixed to the platform. The lock may include a resilient connector that resiliently connects the notch to the base. The resilient connector upwardly biases the notch relative to the base. The lock may include a pedal that projects from the notch and that is configured to release the notch from the one of the transverse side frames when the pedal is depressed by an operator. An entirety of the notch is arranged inwardly with respect to a first end of the wheeled body. When the lock is not releasably locked to the one of the transverse side frames the lock is configured to releasably lock to another one of the transverse side frames. The wheeled body is a first wheeled body and the device may include a second wheeled body. The second wheeled body may include: a platform configured to slidingly receive guide wheels of the main body; wheels mounted to a bottom of the platform; and a lock. The lock may include a notch having dimensions that are complementary to the dimensions of each of the transverse side frames and that is configured to releasably lock to another one of the transverse side frames to restrict longitudinal movement of the main body relative to the wheeled body. The lock of the second wheeled body is wholly incorporated onto the second wheeled body. The first wheeled body and the second wheeled body are identical. The first wheeled body is configured to abut the second wheeled body and the main body is configured to slide along the guide wheels from the platform of the first wheeled body to the platform of the second wheeled body and to automatically lock the notch of the second wheeled body to the other one of the transverse sides.

Another general aspect of the present disclosure is a device that includes a main body and a wheeled body. The main body may include shelves, which may include a first shelf. The first shelf may include transverse side frames. The main body may include support posts that support the shelves and guide wheels mounted to a bottom of the first shelf. The wheeled body may include: a platform configured to slidingly receive the guide wheels of the main body; wheels mounted to a bottom of the platform; and guide rails extending upwardly from a top of the platform. The guide rails define an open space in a region above the platform.

Implementations may include one or more of the following features. The device where the guide rails do not extend inwardly above the platform. The wheeled body may include a lock may include a notch having dimensions that are complementary to dimensions of each of the transverse side frames and that is configured to releasably lock to one of the transverse side frames to restrict longitudinal movement of the main body relative to the wheeled body. The guide rails are configured to guide the guide wheels of the main body towards the lock when the main body slides longitudinally along the platform on the guide wheels.

Another general aspect of the present disclosure is a device that includes a main body and a wheeled body. The main body may include shelves, which may include a first shelf. The first shelf may include transverse side frames. The main body may include support posts that support the shelves and guide wheels mounted to a first shelf of the shelves. The wheeled body. may include a platform configured to slidingly receive guide wheels of the main body; wheels mounted to a bottom of the platform; and a handle mounted to the bottom of the platform. The handle extends upwardly away from the platform at an angle greater than 90 degrees relative to a top of the platform.

Implementations may include one or more of the following features. The device where the main body may include a handle. The wheeled body may include a lock may include a notch having dimensions that are complementary to dimensions of each of the transverse side frames and that is configured to releasably lock to one of the transverse side frames to restrict longitudinal movement of the main body relative to the wheeled body. An entirety of the notch is arranged inwardly with respect to a first end of the wheeled body. When the notch releasably locks the one transverse side a longitudinal spacing is defined between the handle of the wheeled body and the handle of the main body. The lock may include: a base that is fixed to the platform; a resilient connector that resiliently connects the notch to the base, where the resilient connector upwardly biases the notch relative to the base; and a pedal that projects from the notch and that is configured to release the notch from the one of the transverse side frames when the pedal is depressed by an operator.

Various additional features and advantages of this present disclosure will become apparent to those of ordinary skill in the art upon review of the following detailed description of the illustrative embodiments taken in conjunction with the accompanying drawings.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 shows a perspective view of a device with a main body locked to a first wheeled body in an uncontrolled environment;

FIG. 2 shows a perspective view of the device as the main body is transferred from the first wheeled body to a second wheeled body in a controlled environment;

FIG. 3 shows a perspective view of the device with the main body locked to the second wheeled body in the controlled environment;

FIG. 4 shows a perspective view a main body;

FIG. 5 shows a bottom view of the main body of FIG. 4;

FIG. 6 shows a perspective view of a wheeled body;

FIG. 7 shows a front view of the wheeled body of FIG. 6;

FIG. 8 shows a side view of the wheeled body of FIG. 6;

FIG. 9 shows a top view of the device of FIG. 3;

FIG. 10 shows a section view of the device of FIG. 9 along section A-A;

FIG. 11 shows a magnified view of the device of FIG. 10 within region A; and

FIG. 12 shows a magnified view of the device of FIG. 10 within region B.

### DETAILED DESCRIPTION

In describing embodiments of the present disclosure illustrated in the drawings, specific terminology will be resorted to for the sake of clarity. However, the present disclosure is not intended to be limited to the specific terms so selected, and it is to be understood that each specific term includes all technical equivalents that operate in similar manner to accomplish a similar purpose. Several embodiments of the present disclosure are described for illustrative purposes, but it is to be understood that the present disclosure may be embodied in other forms not specifically shown in the drawings.

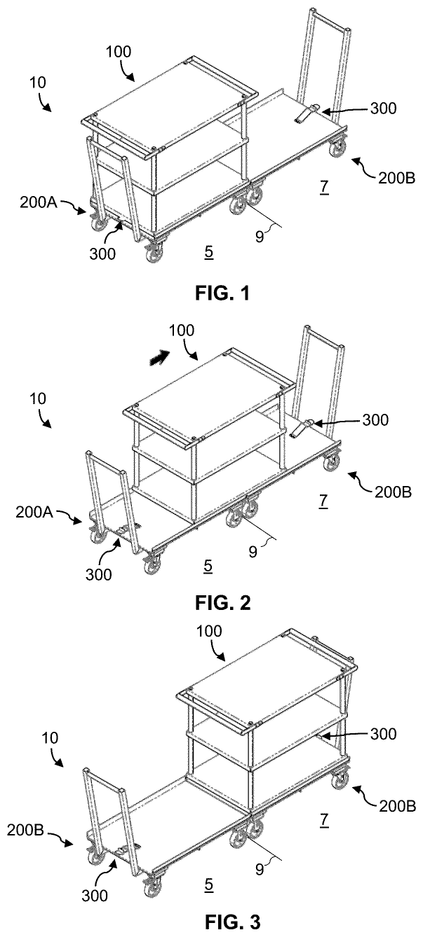

FIGS. 1-3 show a device 10, such as cart, for transporting various objects according to one illustrative non-limiting embodiment of the present disclosure. The device 10 can include a main body 100 (e.g., a frame) and a wheeled body. In embodiments such as shown in FIGS. 1-3, the device 10 can include a first wheeled body 200A and a second wheeled body 200B, though the device 10 can include any number of wheeled bodies including only a single wheeled body. In embodiments in which the device 10 includes more than one wheeled body each wheeled body can include the same features and can have the same structural relationships with the main body 100. Accordingly, any subsequent description of features or structural relationships described herein in reference to the wheeled body can apply to any other wheeled body of the device 10 including the first wheeled body 200A and the second wheeled body 200B. For example, each wheeled body can include a lock 300 that can releasably lock the main body 100 to the respective wheeled body 200A, 200B. In alternative embodiments, the device 10 can include multiple wheeled bodies and at least some of the wheeled bodies can include features or structural relationships different from at least one other of the wheeled bodies.

The device 10 can be used, for example, to move items (such as goods, product and/or equipment) from an uncontrolled environment 5 (e.g., outside a clean room) to a controlled environment 7 (e.g., inside a clean room). These items may be sterile and exposed or scaled inside sealed packaging such as bags. In embodiments, a single operator can operate the device 10 to move the items from the uncontrolled environment 5 to the controlled environment 7. A boundary 9 can separate the controlled environment 7 and the uncontrolled environment 5. In embodiments, the boundary 9 can be, for instance, an entrance to an airlock located outside a clean room. Or, the boundary 9 can be inside the airlock and outside the entrance to the clean room. Or, the boundary 9 can be between two clean rooms having different particulate levels. For instance, the device 10 can move items from an ISO 14644-1 class clean room to an ISO 14644-2 class clean room. Items can be carried on the shelves of the main body 100.

FIGS. 1-3 illustrate a transfer of the main body 100 from the first wheeled body 200A in the uncontrolled environment 5 to the second wheeled body 200B in the controlled environment 7. As shown in FIG. 1, the main body 100 can be releasably locked to first wheeled body 200A by the lock 300. The first wheeled body 200A can be located in the uncontrolled environment 5 and can be brought by the operator to one side of the boundary 9. The second wheeled body 200B can be located in the controlled environment 7 and can be brought into abutment with the first wheeled body 200A at the other side of the boundary 9. Alternatively, the second wheeled body 200B can first be brought to the boundary 9 and the first wheeled body 200A can be brought into abutment with the second wheeled body 200B at the boundary 9.

As shown in FIG. 2, the operator can unlock the lock 300 of the first wheeled body 200A, which can thereby allow the main body 100 (together with any items it is carrying) to slide relative to the first wheeled body 200A. For example, the main body 100 can include guide wheels that can wheel the main body 100 off of the first wheeled body 200A and onto the second wheeled body 200B that abuts first wheeled body 200A at the boundary 9. As discussed previously, the first wheeled body 200A and the second wheeled body 200B can include the same features and structural relationships with the main body 100. Accordingly, when the first wheeled body 200A and the second wheeled body 200B abut at the boundary 9 platforms of the first wheeled body 200A and the second wheeled body 200B can be at the same height to allow for a smooth transfer for the main body 100 from the first wheeled body 200A to the second wheeled body 200B. In embodiments, the first wheeled body 200A and the second wheeled body 200B can be identical. In embodiments, the operator can manually align the first wheeled body 200A with the second wheeled body 200B so that the respective sides of the first wheeled body 200A and the second wheeled body 200B substantially align with each other. In certain embodiments, a guide member can be provided on a front end of the first wheeled body 200A and/or of the second wheeled body 200B to (individually or jointly) assist the operator in aligning the first wheeled body 200A with the second wheeled body 200B. One or more wheels of the first wheeled body 200A and/or of the second wheeled body 200B can each be locked to prevent relative movement between the first wheeled body 200A and the second wheeled body 200B during transfer of the main body 100.

As shown in FIG. 3, once the main body 100 is fully received on the second wheeled body 200B the lock 300 of the second wheeled body 200B can automatically releasably lock the main body 100 to the second wheeled body 200B, which can prevent relative movement between the main body 100 and the second wheeled body 200B. The main body 100 can thus be locked the second wheeled body 200B, which can have sterile wheels inside the controlled environment 7. The first wheeled body 200A, which can have unsterile wheels, can remain in the uncontrolled environment 5. The wheels of the second wheeled body 200B can then be unlocked by the operator and the second wheeled body 200B can be maneuvered inside the controlled environment 7 so that the items on the main body 100 can be delivered to the appropriate location inside the controlled environment 7. During the transfer of the main body 100 from the first wheeled body 200A to the second wheeled body 200B, the items can remain the shelves main body and need not be removed. In addition, the main body 100 can be transferred between the first wheeled body 200A and the second wheeled body 200B without ever touching the ground, which can isolate the items on the main body 100 from ground contaminants. In embodiments, the main body 100 can be transferred from the second wheeled body 200B to the first wheeled body 200A in a similar but reversed manner.

Thus, the device 10 can enable items to be carried on the shelves of the main body 100 as the main body 100 is moved between the uncontrolled environment 5 and the controlled environment 7. In this way, an operator need not manually remove the items from a cart to bring the items into the controlled environment 7, while leaving the cart outside of the controlled environment 7. And, the wheels that are used in the uncontrolled environment 5 (e.g., the wheels of the first wheeled body 200A) do not enter the controlled environment 7. Rather, the wheels used in the controlled environment 7 (e.g., the wheels of the second wheeled body 200B) can remain inside the controlled environment 7 and do not need to leave the controlled environment 7 to receive items. Accordingly, the wheels (e.g., the wheels of the first wheeled body 200A) that contact the ground surface in the uncontrolled environment 5 do not introduce contaminants into the controlled environment 7.

In embodiments, the device 10 can have an elongated, rectangular shape. In embodiments, an entirety of the device 10, including an entirety of the main body 100, an entirety of the first wheeled body 200A, and an entirety of the second wheeled body 200B, can be made of a material that can withstand the moisture, heat, and pressure necessary for an entirety of the device 10 to be autoclaved. Such materials may include, but are not limited to, metals and metal alloys such as nickel, aluminum or stainless steel, resilient plastics such as polypropylene, and Pyrex type glass.

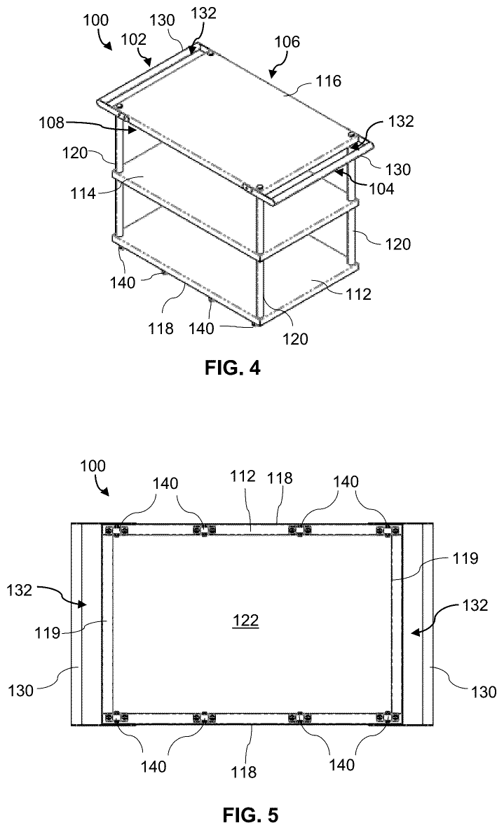

FIGS. 4 and 5 respectively show a perspective view and a bottom view of the main body 100 according to aspects of the present disclosure. The main body 100 can be a frame. The main body 100 can be rectangular. The main body 100 can be a discrete body that can define a first end 102 (e.g., a transverse side), a second end 104 (e.g., a transverse side), a third end 106 (e.g., a longitudinal side), and a fourth end 108 (e.g., a longitudinal side). The main body 100 can include one or more shelves that can carry various items, such as goods and/or equipment. The shelves can be horizontally-extending. In embodiments such as shown in FIG. 4, the main body 100 can include a first shelf 112 (e.g., a bottom shelf), a second shelf 114 (e.g., a middle shelf), and a third shelf 116 (e.g., a top shelf) though any number of shelves are possible. The main body 100 can include any number of vertical support posts 120. In embodiments such as shown in FIG. 4, the main body 100 can include four vertical support posts 120 that can connect to and support each of the first shelf 112, the second shelf 114, and the third shelf 116. A single support post 120 can be provided at each corner that extends from the bottom shelf to the top shelf; or a lower support post can extend from the bottom shelf to the middle shelf and an upper support post can extend from the middle shelf to the top shelf. In embodiments, any or all of the shelves can have edges that turn upwardly or downwardly to form side walls, which can provide further support for the shelves and/or can prevent the items being transported from sliding off the shelves. The first shelf 112, the second shelf 114, and/or the third shelf 116 can include a frame that can surround a perimeter of the respective shelf. For example, and as shown in FIG. 5, the first shelf 112 can include a flat metal top shelf platform or sheet and a frame that comprises longitudinal side frames or frame members 118 and transverse side frames or frame members 119 that connect the longitudinal side frames 118 together. The top shelf platform is placed on the frame members 118, 119, such that the frame members 118, 119 extend downward from the top shelf platform, as best shown in FIG. 12. The longitudinal side frames 118 and transverse side frames 119 can form any number of shapes and/or sizes including for example a square, rectangular, triangle, or tubular shape.

The main body 100 can include one or more handles 130. In embodiments such as shown in FIG. 4, the main body 100 can include two handles 130 respectively connected to the first end 102 and the second end 104. The handles 130 can be round elongated tubes that span the width of the main body 100 and that can include supports to connect. The handles 130 can be respectively connected to the first end 102 and the second end 104 by supports. The respective handles 130 can be spaced apart and arranged parallel to the first end 102 and the second end 104 to form respective gaps 132 between the respective handles 130 and first end 102 and the second end 104. The handles 130 can arranged substantially at a top of the main body 100 and can be level with or raised up from (by the supports) the third shelf 116.

The main body 100 can include guide wheels 140 that can facilitate sliding of the main body 100 along the wheeled body 200 during transfer. In embodiments such as shown in FIGS. 4 and 5, the guide wheels 140 can be mounted to a bottom 122 of the first shelf 112. For example, the guide wheels 140 can be mounted to bottoms of the longitudinal side frames 118. In embodiments such as shown in FIGS. 4 and 5, the guide wheels 140 can be mounted inwardly with respect to ends longitudinal side frames 118 of the first shelf 112, which can allow the longitudinal side frames 118 to slide against complimentary walls of the wheeled body 200 without interference from the guide wheels 140 to more smoothly align the main body 100 with the wheeled body 200 during transfer of the main body 100 to the wheeled body 200. And as shown in FIG. 12, the guide wheels 140 extend downward from the longitudinal side frames 118 so that there is a space or gap between the top surface of the wheeled body platform 240 and the bottom of the transverse side frames 119.

In embodiments, four guide wheels 140 can be positioned on each side of the bottom 122 inside of the longitudinal side frames 118 spaced apart from each other, though any number of guide wheels 140 can be provided. Each guide wheel 140 can include a wheel and an axle mounted to the bottom 122 of the first shelf 112. In embodiments, the axle can be just slightly larger than the wheel, or the axle can extend the entire width of the main body 100 and each axle can support one or more wheels. The guide wheels 140 can extend entirely below the longitudinal side frames 118 and can support the weight of the main body 100 when slidably received on the wheeled body 200. The guide wheels 140 rotate about an axis of rotation that is parallel to a longitudinal axis of the main body 100, i.e., forward/backwards. Thus, the guide wheels 140 can rotate when the main body 100 is slidably received and removed from the wheeled body 200. The axis of rotation for each of the guide wheels 140 can be perpendicular to the longitudinal side frames 118.

In embodiments, the main body 100 can include any number of guide wheels 140 or rollers. For example, the main body 100 can include rollers on each side of the top of the main body 100, which can prevent the main body 100 from tipping during transfer. In embodiments, the main body 100 can include four rollers on each side, though other combinations of rollers are possible. In further embodiments, the guide wheels 140 need not be provided, and instead the bottom (bottom surface) 122 of the first shelf 112 can slide on the top (top surface) of the wheeled body platform 240 of the wheeled body 200.

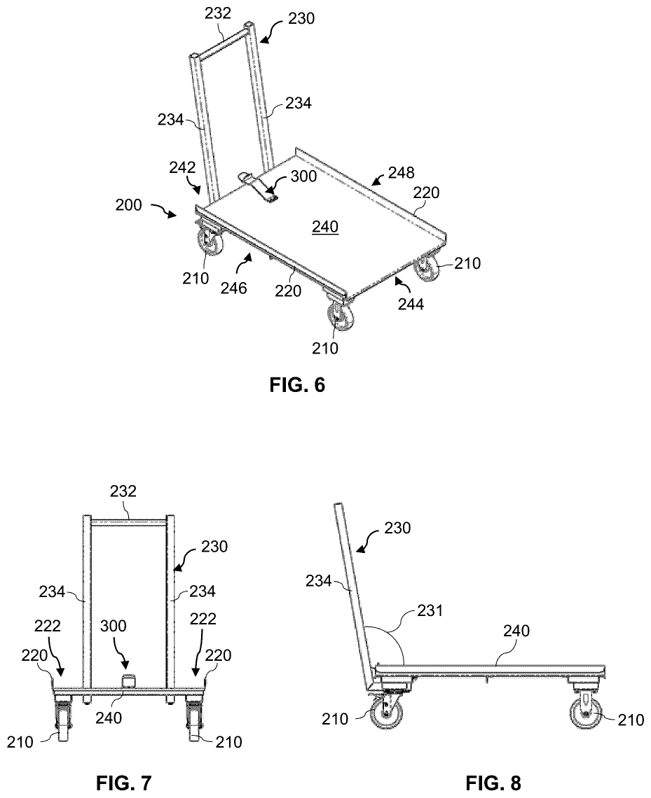

FIGS. 6-8 respectively show perspective, front, and side views of the wheeled body 200 according to aspects of the present disclosure. As described previously, the first wheeled body 200A and the second wheeled body 200B can include any of the features and/or structural relationships described in reference to the wheeled body 200. The wheeled body 200 can include wheels 210. In embodiments, each of the wheels 210 can include a wheel frame and a wheel rotatably coupled with the wheel frame. The wheels 210 can be connected to the bottom of the wheeled body platform 240 and the wheels 210 can be provided at each of the four corners of the wheeled body 200 so that the wheeled body 200 can be easily maneuvered by the operator. At least one of the wheels 210 can include a wheel lock mechanism that can prevent movement of the wheeled body 200. In embodiments, one or more of the wheels 210 can be swivel mounted and rotatable to improve maneuverability of the wheeled body 200.

The wheeled body 200 can include a wheeled body platform 240. The wheeled body platform 240 can be sized and shaped to cooperatively receive and mate with the main body 100. In embodiments, the platform 240 can be a flat, rectangular, elongated, thin sheet. The platform 240 can define a first end 242 (e.g., a transverse side), a second end 244 (e.g., a transverse side), a third end 246 (e.g., a longitudinal side), and a fourth end 248 (e.g., a longitudinal side). The platform 240 can have a flat top surface that can be a single continuous sheet. In embodiments, the platform 240 can include one or more elongated slats that extend the full length of the wheeled body 200 from the first end 242 to the second end 244 and/or from the third end 246 to the fourth end 248. The platform 240 can be supported by the wheels 210 relatively low to the ground (e.g., 3-8 inches, depending on the size of the wheels 210) to provide a stable base upon which the main body 100 can be fixed. Accordingly, the height of the wheeled body 200 can be minimized.

The wheeled body 200 can include guiderails 220 that can guide the main body 100 during transfer and that can facilitate securing the main body 100 to the wheeled body 200. For example, the guiderails 220 can guide the guide wheels 140 of the main body 100 as the main body 100 slides along the platform 240 of the wheeled body 200. In embodiments, the guide wheels 140 can be provided entirely between the guiderails 220 when the main body 100 slides along the platform 240 and when the main body 100 is releasably locked to the wheeled body 200. The guiderails 220 can respectively be provided at each of the third end 246 and the fourth end 248. In embodiments, the guiderails 220 can extend along an entire length of the wheeled body 200. Each guiderail 220 can extend perpendicularly upward or upward and slightly outward from platform 240. The guiderails 220 prevent the guide wheels 140 from inadvertently sliding off the end (the longitudinal sides 242, 244 in the embodiment shown) of the platform 240. In other embodiments, multiple guiderails 220 can be provided spaced apart from each other at each of the third end 246 and the fourth end 248.

As shown in FIG. 7, each of the guiderails 220 can define an open space 222 in a region above the platform 240, that is on a side of the platform 240 opposite to a side of the platform 240 that the wheels 210 are mounted to. In embodiments, the guiderails 220 only extend vertically and for example do not extend inwardly above the platform 240. The open space 222 can allow the main body 100 to be freely lifted off or placed onto the platform 240 without interference from the guiderails 220. This can improve options for sanitizing the main body 100 and/or the wheeled body 200 and can provide an alternative path for transferring the main body 100 from the wheeled body 200. In embodiments, the guiderails 220 can be formed, for instance, by bending the sides of the platform 240 so that the guiderails 220 can be integral with the platform 240, for example, can be formed as a single piece with the platform 240 and be turned upright. Alternatively, the guiderails 220 can be discrete parts attached to the sides of the platform 240. Corners and/or edges of the guiderails 220 can be beveled to guide the main body 100 inwardly between the guiderails 220 as the main body 100 slides onto the wheeled body 200.

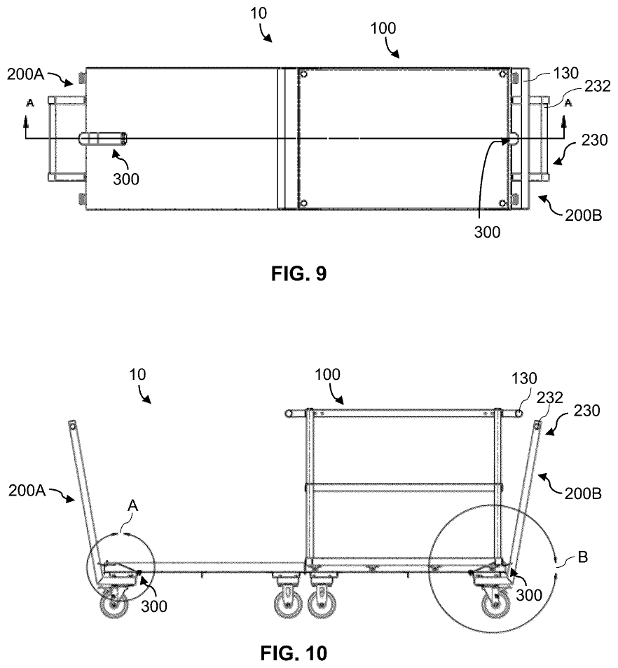

The wheeled body 200 can include a handle 230 that an operator can grip to maneuver the wheeled body 200. The handle 230 can be mounted to the platform 240, for example, at a bottom of the platform 240, such that the handle 230 does not interfere with the structural relationship between the lock 300 and the main body 100. The length of the handle 230 can be shorter than the height of the handle 130 (i.e., the length of the vertical support post 120), so that the grip 232 of the handle 230 is vertically spaced apart from the handle 130 of the main body 100 when the main body 100 is locked to the wheeled body 200 by the lock 300, as shown for example in FIGS. 9 and 10. In addition, the handle 230 can be connected to the platform 240 such that a grip 232 of the handle 230 is horizontally spaced apart from the handle 130 of the main body 100 when the main body 100 is locked to the wheeled body 200 by the lock 300, as shown for example in FIGS. 9 and 10. According to this configuration an operator can more easily grip the grip 232 without interference from the handle 130. And the user can push the handle 130 without interference from the grip 232. For example, the handle 230 can extend upwardly away from the platform 240 at an obtuse angle 231 relative to a top of the platform 240. The angle 231 can be greater than 90 degrees such that the grip 232 at the top of the handle 230 can be horizontally spaced from the handle 130 of the main body 100 when the main body 100 is locked to the wheeled body 200. That is, the grip 232 is positioned further away from the nearest vertical support post 120 than the handle 130 is from that same vertical support post 120. Alternatively, at least part of the handle 230 can extend perpendicularly from the platform 240 and the grip 232 can be offset. In such a configuration, an angle can be formed between a virtual line extending from the first end 242 or the second end 244 through the grip 232 and the platform 240 surface, and that angle can be greater than 90 degrees such that the grip 232 at the top of the handle 230 can be horizontally spaced from the handle 130 of the main body 100 when the main body 100 is locked to the wheeled body 200.

In addition, as best shown in FIG. 9, the main body handle 130 can extend the entire width of the main body; whereas the wheeled body handle 230 is shorter than the main body 130, for instance the wheeled body handle 230 can only extend at the middle of the wheeled body 200 and not extend the entire width of the wheeled body or the main body. The wheeled body 200 and the main body 100 are approximately the same width and length, to maximize the size of the main body 100 and its carrying capacity. The main body handle 130 can be used during transport, so the wider handle 130 allows for greater control by the user. The wheeled body handle 230 can also be used during transport, but is primarily used to hold the wheeled body 200 in place as the main body 100 is transferred from one wheeled body 200 to another. Thus, the wheeled body handle 230 can be smaller in length than the main body handle 130.

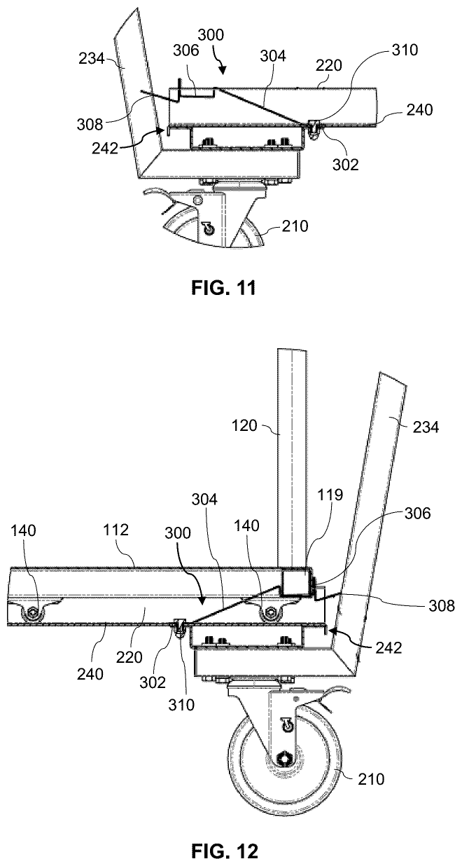

As best shown in FIGS. 11-12, the handle 230 can include supports 234 that rigidly support the grip 232 and that fixedly connect the grip 232 to the platform 240. The support 234 can have a circular, rectangular or square cross-section and are elongated, with a base portion and an arm portion. The base portion is short and extends horizontally. A cross-support bracket member is coupled to the bottom of the wheeled body platform 240, and extends the entire width of the wheeled body 200. The wheels 210 are connected to the bottom of the cross-support bracket member. The base portion of support 234 is connected to the cross-support bracket member. The wheels 210 are connected to the bracket toward the outermost sides, and the base portion of support 234 is connected to the bracket inside of the wheels 210. The bracket extends downward from the wheeled body platform 240 and has a U-shaped cross section with flat horizontal tops that are connected to the bottom of the wheeled body platform 240. The arm portion of the support 234 extends upward from the base portion at an obtuse angle thereto, so that the support 234 does not obstruct the user at the bottom of the cart and angles away from the platform to be more easily grabbed by the user. In embodiments, the grip 232 and the supports 234 can be integral. Alternatively, the grip 232 and the supports 234 can be distinct structures connected together.

The wheeled body 200 can include the lock 300, as best shown in FIGS. 6-7 and 9-12. FIG. 9 shows a top view of the device 10 with the main body 100 locked to the second wheeled body 200B. FIG. 10 shows a cross section view of the device 10 of FIG. 9 taken along line A-A. FIG. 11 shows a magnified view of the lock 300 of the first wheeled body 200A in a disengaged positioned within region A of FIG. 10. FIG. 12 shows a magnified view of the lock of the second wheeled body 200B in the engaged position within region B of FIG. 10. The lock 300 can include a unitary body that can be bent and/or molded into distinct portions that can include for example a base 302, a resilient connector or member 304, a lock channel or notch 306, and a pedal 308. The lock 300 can be, for example, a thin rigid elongated sheet metal.

The base 302 can be fixed to the platform 240 by a fastener or fixing 310, which can include any of a bolt, nut, screw, rivet, or functional equivalent. For example, the fastener can extend through a through-hole in the base 302.

The lock 300 can be wholly incorporated into the wheeled body 200 without any component of the lock 300 being provided on the main body 100. According to this configuration, manufacturability can be improved and costs associated with manufacturing can be reduced. For example, the notch 306 can have a complimentary size, shape and dimension to a size, shape and dimension of the transverse side frame members 119 such that either of the transverse side frames 119 can be received within and fixed by the notch 306 to lock the main body 100 to the wheeled body 200. The lock 300 is elongated and has a longitudinal lock axis that extends along a longitudinal main body axis of the main body 100 and orthogonal to a longitudinal axis of the transverse side frame 119. According to this configuration, the main body 100 does not include any extraneous lock components since the lock 300 is complementary to the transverse side frames 119 of the existing main body 100. For example, the notch 306 can have a width in the longitudinal direction of the wheeled body 200 that is slightly larger (e.g., between 1% and 5% larger) than a width of the transverse side frames 119 in the longitudinal direction of the wheeled body 200 such that the transverse side frames 119 can be received within and can be fixed by the notch 306. The notch 306 can have a depth that is sufficient to hold the transverse side frame 119 and to prevent the transverse side frame 119 from being inadvertently dislodged from the notch 306. The resilient connector 304 can resiliently connect the notch 306 to the base 302.

For example, in the embodiment shown, the transverse side frame member has a square or rectangular cross-section and the notch 306 has a flat bottom and sides that extend orthogonally upward from the flat bottom, to match the shape and size of the transverse side frame. The flat bottom surface of the transverse side frame 119 rests on the bottom of the notch and the leading front side of the transverse side frame 119 contacts the leading front wall of the notch, and the trailing rear wall of the transverse side frame 119 contacts the trailing rear wall of the notch 306, whereby the notch 306 reliably and lockably engages the transverse side frame 119. However, in other embodiments, the transverse side frame member can have a circular cross-section and the notch can have a curved bottom and sides to reliably and lockably engage the transverse side frame. A longitudinal axis of the notch 306 extends substantially orthogonal to a longitudinal axis of the transverse side member 119.

The notch 306 can be arranged inwardly with respect to the first end 242 of the wheeled body 200 when the notch 306 is engaged with the transverse side frame 119. For example, an entirety of the notch 306 can be arranged inwardly with respect to the first end 242. These configurations together with the configuration of the handle 230 can ensure that there is a longitudinal spacing between the handle 230 and the handle 130 when the main body 100 is engaged with the wheeled body 200 to improve usability of the handle 230, as previously described. In the embodiments shown, the notch 306 has a lip, bottom, and a stop member. The lip extends vertically downward from the end of the resilient connector 304. The bottom extends substantially horizontal and parallel to the platform 240. The stop member extends vertically upward from the bottom, and is opposite to and parallel with the lip.

A fastener 310 connects the base 302 of the connector 304 to the wheeled body platform 240 at a distance inward from the transverse sides 242, 244 (a separate lock 300 for each side 242, 244). The resilient connector 304 extends toward the respective transverse side 242, 244 and is angled upward from the wheeled body platform 240. In this manner, the resilient connector 304 can upwardly bias (i.e., in a direction away from the top surface of the wheeled body platform 240) the notch 306 as shown for example in the disengaged position of FIG. 11 and the engaged position of FIG. 12. Moreover, the connector 304 extends in the space between the top surface of the wheeled body platform 240 and the bottom surface of the main body 100, and particularly the bottom of the transverse frame member 119. The space between the wheeled body platform 240 and the transverse frame member 119 is created by the guide wheels 140, and allows the lock 300 to move upward and downward. In that manner, the main body 100 can automatically engage the notch 306 when the main body is slid onto a respective wheeled body 200. For example, the lock 300 can extend longitudinally along the longitudinal direction of the wheeled body 200 parallel to the guiderails 220 such that the guiderails 220 can guide the main body 100 to the notch 306 when the main body 100 is slid onto a respective wheeled body 200. The resilient connector 304 is linear and formed at an obtuse angle with respect to the base 302. Accordingly, when the base 302 is fixed to the wheeled body platform 240, for example by the fastener 310 extending through an opening in the base 302 into the top wheeled body platform 240, the resilient connector 304 extends upward away from the platform at an angle to the wheeled body platform 240 and due to its length can flex slightly to form a spring that can move upward and downward with respect to the platform 240.

The pedal 308 can be connected to the notch 306 and can be depressed by an operator, for example using a foot of the operator, to overcome the upward bias of the resilient connector 304 and to disengage or engage the notch 306 and a respective transverse side frame 119. The pedal 308 extends outward from the distal edge of the platform 240, so that it can be readily accessed by the user. Thus, the pedal 308 can selectively unlock the notch 306 and the transverse side frame 119 to allow the main body 100 to move freely in the longitudinal direction of the wheeled body 200. Once the pedal 308 is released by the operator, the upward bias provided by the resilient connector 304 can return the notch 306 to the engaged or disengaged positions respectively shown in FIGS. 11 and 12. In the engaged and disengaged positions shown in FIGS. 11 and 12, the resilient connector 304 can hold the notch 306 at a position in which the bottom of the notch 306 is spaced a distance from the a top of the platform 240. The distance can be a distance that is sufficient to disengaged the notch 306 and the respective transverse side frame 119 when the pedal 308 is fully depressed to release the main body 100 from the lock 300. The pedal 308 can project from the notch 306.

Thus, in operation, the user can transfer a main body 100 from a first wheeled body 200A to a second wheeled body 200B. The user brings the wheeled bodies 200A, B together, FIG. 1, and locks the respective wheels 210. The user then uses a foot to depress the lock pedal 308 downward against the upward spring action of the resilient connector 304, until the notch lip is below the transverse side frame 119. That unlocks the lock 300 from the main body 100 and allows the user to push the handle 102 to roll the main body 100 in a forward direction off of the first wheeled body 200A and onto the platform of the second wheeled body 200B. As the main body 100 approaches the distal end of the second wheeled body 200B, FIG. 2, the bottom leading edge of the transverse side frame 119 (or other element) comes into contact with the top surface of the angled resilient connector 304. As the main body 100 continues to be received on the second wheeled body 200B in the forward direction, the leading bottom edge of the transverse side frame 119 forces the resilient connector 304 downward against the upward bias of the resilient connector 304. The second wheeled body 200B continues in the forward direction, FIG. 2, until the transverse side frame member 119 passes the notch lip and comes into contact with the stop member which halts further forward progress of the second wheeled body 200B, FIG. 3. At that point, the notch 306 is aligned with the transverse side frame 199, and the resilient connector 304 forces the notch 306 upward to releasably engage the transverse side frame 199, thereby locking the notch 306 to the side frame 199 and the main body 100 to the second wheeled body 200B, FIG. 12. That upward motion causes an audible sound when the side frame 199 strikes the bottom of the notch, which indicates to the user that the lock is engaged. The notch lip prevents the transverse side frame 199 of the main body 100 from moving in a reverse or rearward direction, and the notch stop member prevents the transverse side frame 199 from moving in a further forward direction.

In the example embodiments shown and described, the lock 300 is configured so that it locks to a standard feature of the main body 100, namely the transverse side frame 119. It should be further noted that the main body 100 can be provided with a lock feature, such as an opening, adapter or lock mechanism, that releasably engages with the lock. And the lock can have any suitable structure not limited to the disclosed embodiments.

Accordingly, the disclosure simplifies the wheeled body and locking mechanism, and reduces cost. It provides transferability of the main body from one wheeled body to another, minimizes contamination entering a clean room, and provides a more efficient mechanism for bringing products, raw materials, and equipment, etc. into the clean room, including heavier items, without injury to the user. One or more wheeled bodies are dedicated to the clean room, and one or more wheeled bodies are dedicated to remain outside the clean room. The entire unit can be thoroughly cleaned, such as by autoclave. The locking mechanism is reliable and easy to lock and unlock.

It is noted that the drawings may illustrate, and the description and claims may use geometric or relational terms, such as above, below, side, upward, downward, inward, forward, rearward, top, bottom, linear, square, rectangular, circular, curved, elongated, parallel, orthogonal, perpendicular. These terms are not intended to limit the disclosure and, in general, are used for convenience to facilitate the description based on the examples shown in the figures. In addition, the geometric or relational terms may not be exact. For instance, walls may not be exactly perpendicular or parallel to one another because of, for example, roughness of surfaces, tolerances allowed in manufacturing, etc., but may still be considered to be perpendicular or parallel.

It will be appreciated that the foregoing description provides examples of the present disclosure. However, it is contemplated that other implementations of the present disclosure may differ in detail from the foregoing examples. All references to the present disclosure or examples thereof are intended to reference the particular example being discussed at that point and are not intended to imply any limitation as to the scope of the present disclosure more generally. All language of distinction and disparagement with respect to certain features is intended to indicate a lack of preference for those features, but not to exclude such from the scope of the present disclosure entirely unless otherwise indicated.

1. A device comprising:
a main body comprising:
shelves comprising a first shelf, the first shelf comprising transverse side frames;
support posts that support the shelves; and
guide wheels mounted to the first shelf; and
a wheeled body comprising:
a platform configured to slidingly receive the guide wheels of the main body;
wheels mounted to a bottom of the platform; and
a lock comprising a notch having dimensions that are complementary to dimensions of each of the transverse side frames and that is configured to releasably lock to one of the transverse side frames to restrict longitudinal movement of the main body relative to the wheeled body, wherein the lock is wholly incorporated onto the wheeled body.

2. The device of claim 1, wherein the lock comprises a base that is fixed to the platform.

3. The device of claim 2, wherein the lock comprises a resilient connector that resiliently connects the notch to the base.

4. The device of claim 3, wherein the resilient connector upwardly biases the notch relative to the base.

5. The device of claim 3, wherein the lock comprises a pedal that projects from the notch and that is configured to release the notch from the one of the transverse side frames when the pedal is depressed by an operator.

6. The device of claim 1, wherein an entirety of the notch is arranged inwardly with respect to a first end of the wheeled body.

7. The device of claim 1, wherein when the lock is not releasably locked to the one of the transverse side frames the lock is configured to releasably lock to another one of the transverse side frames.

8. The device of claim 1, wherein the wheeled body is a first wheeled body and the device comprises a second wheeled body, the second wheeled body comprising:
a platform configured to slidingly receive the guide wheels of the main body;
wheels mounted to a bottom of the platform; and
a lock comprising a notch having dimensions that are complementary to the dimensions of each of the transverse side frames and that is configured to releasably lock to another one of the transverse side frames to restrict longitudinal movement of the main body relative to the wheeled body, wherein the lock of the second wheeled body is wholly incorporated onto the second wheeled body.

9. The device of claim 8, wherein the first wheeled body and the second wheeled body are identical.

10. The device of claim 8, wherein the first wheeled body is configured to abut the second wheeled body and the main body is configured to slide along the guide wheels from the platform of the first wheeled body to the platform of the second wheeled body and to automatically lock the notch of the second wheeled body to the other one of the transverse sides.

11. A device comprising:
a main body comprising:
shelves comprising a first shelf, the first shelf comprising transverse side frames;
support posts that support the shelves; and
guide wheels mounted to a bottom of the first shelf; and
a wheeled body comprising:
a platform configured to slidingly receive the guide wheels of the main body;
wheels mounted to a bottom of the platform; and
guide rails extending upwardly from a top of the platform, wherein the guide rails define an open space in a region above the platform.

12. The device of claim 11, wherein the guide rails do not extend inwardly above the platform.

13. The device of claim 11, wherein the wheeled body comprises a lock comprising a notch having dimensions that are complementary to dimensions of each of the transverse side frames and that is configured to releasably lock to one of the transverse side frames to restrict longitudinal movement of the main body relative to the wheeled body.

14. The device of claim 13, wherein the guide rails are configured to guide the guide wheels of the main body towards the lock when the main body slides longitudinally along the platform on the guide wheels.

15. A device comprising:
a main body comprising:
shelves comprising a first shelf, the first shelf comprising transverse side frames;
support posts that support the shelves; and
guide wheels mounted to the first shelf; and
a wheeled body comprising:
a platform configured to slidingly receive the guide wheels of the main body;
wheels mounted to a bottom of the platform; and
a handle mounted to the bottom of the platform, wherein the handle extends upwardly away from the platform at an angle greater than 90 degrees relative to a top of the platform.

16. The device of claim 15, wherein the main body comprises a handle.

17. The device of claim 16, wherein the wheeled body comprises a lock comprising a notch having dimensions that are complementary to dimensions of each of the transverse side frames and that is configured to releasably lock to one of the transverse side frames to restrict longitudinal movement of the main body relative to the wheeled body.

18. The device of claim 17, wherein an entirety of the notch is arranged inwardly with respect to a first end of the wheeled body.

19. The device of claim 18, wherein when the notch releasably locks the one transverse side a longitudinal spacing is defined between the handle of the wheeled body and the handle of the main body.

20. The device of claim 19, wherein the lock comprises:
a base that is fixed to the platform;
a resilient connector that resiliently connects the notch to the base, wherein the resilient connector upwardly biases the notch relative to the base; and
a pedal that projects from the notch and that is configured to release the notch from the one of the transverse side frames when the pedal is depressed by an operator.

21. A device comprising:
a main body having one or more shelves and a frame member; and
a wheeled body comprising:
a platform configured to slidingly receive main body; and
a lock configured to releasably lock to said frame member to restrict longitudinal movement of the main body relative to the wheeled body.

22. The device of claim 21, wherein said lock comprises a linear resilient member having a base at a first end, said base fixed to said platform, and a channel at a second end opposite the first end, said channel releasably locking to said frame member.
